(19) United States
(12) Patent Application Publication
(10) Pub. No.: US 2022/0077534 A1
(43) Pub. Date: Mar. 10, 2022

(54) BATTERY PACK ASSEMBLY

(71) Applicant: Aceleron Limited, Birmingham, West Midlands (GB)

(72) Inventors: Amrit CHANDAN, Birmingham, West Midlands (GB); Carlton CUMMINS, Birmingham, West Midlands (GB)

(21) Appl. No.: 17/415,632

(22) PCT Filed: Dec. 23, 2019
(86) PCT No.: PCT/GB2019/053689

§ 371 Date: Jun. 17, 2021

(30) Foreign Application Priority Data
Dec. 21, 2018 (GB) 1821086.4

(51) Int. Cl. H01M 50/264; H01M 50/213; H01M 50/258; H01M 50/244

(52) U.S. Cl. CPC H01M 50/264; H01M 50/244; H01M 50/258; H01M 50/213

(57) ABSTRACT

A battery pack assembly, the assembly comprises a first holding frame (10A′) and second holding frame (10B′), a plurality of cells (15A′, 15B′ . . . 15Z′) having terminals (TA′, TB′ . . . TZ') at each end thereof, fastening means (12A′, 12B′ . . . 12Z′) for reversibly holding the first and second holding frames (10A′, 10B′) with respect to one another in a closed condition, an electrically conductive conductor plate (11A′, 11B′) for providing electrical contact to at least two of said plurality of cells (15A′, 15B′ . . . 15Z′), the conductor plate (11A′, 11B′) having respective protrusions for making contact with each of said at least two cells (15A′, 15B′ . . . 15Z′), the first holding frame bearing directly against said conductor plate (11A′, 1B′) to cause the protrusions (17A′, 17B′ . . . 17Z′) of the conductor plate (11A′, 11B′) to make electrical contact with said at least two cells (15A′, 15B′ . . . 15Z′) in said closed condition.

This invention relates generally to a battery pack assembly. More specifically, although not exclusively, this invention relates to a lithium-ion battery pack assembly, for example, a large format battery pack assembly, methods of making the same, and uses of the same.

Lithium-ion batteries are known in a variety of cell formats, cylindrical, prismatic and pouch cells are the most common varieties. In a cylindrical cell the electrode is tightly wound about itself and the terminals are typically found at either end of the cylinder, the electrode being contained within a casing, typically made from aluminium or steel. Due to the shape of the cell packing efficiency may be low but the provision of spaces between adjacent cells is useful for thermal management purposes. The electrodes of prismatic cells can be wound, stacked or folded and are usually located within an aluminium or plastics housing. The terminals are often on one end of the cell which, coupled with the shape of the cell improves packing efficiency. Pouch cells typically have stacked or folded electrodes encased in a flexible plastics casing. The terminals of pouch cells may extend from different sides of the pouch but conveniently they may both extend from one side, for example the top, of the pouch.

It is known to connect lithium-ion batteries or cells in series to increase the voltage to produce a “large format battery pack”. These offer several benefits including high energy density in comparison to their weight, high operating voltage and slow self-discharge. Consequently, large format battery packs of this type find use in a range of both consumer and industrial applications including as emergency power back-up, vehicle power, and solar power storage.

There appears to be no set definition of what constitutes a “large format battery pack”. The UN, for example (e.g. in relation to the UN38.3 Procedure), states that a ‘large battery’ is one that has a mass in excess of 12 kg whereas some manufacturers specify that large batteries or large format battery packs have an energy storage in excess of 1 kWh. For the purposes of this invention we consider that a large format battery pack is one with more than three cells (be they cylindrical, prismatic or pouch) connected in series.

Large format battery packs using cylindrical cells often have a plurality of cells, typically 15 or more cells, electrically connected and presented as a single unit called a battery module. In industry, these modules are typically assembled using permanent assembly techniques (structural adhesives, spot welding, soldering etc.). Such permanent assembly techniques present challenges for repairing or reusing the modules (or the cells or other parts thereof), as the individual components of the assembly cannot easily be accessed or removed. This also makes it difficult to recycle the modules, as the various materials cannot easily be separated.

Accordingly, such production techniques can lead to energy storage products which are not aligned with EU waste management legislations and prohibits greater revenue opportunities in the repair and repurposing of batteries and battery modules.

In our earlier patent GB2545567, a battery pack assembly is described comprising two holding frames for longitudinally holding a plurality of cells therebetween, conductive means for connecting the plurality of cells, fastening means for the reversible assembly and disassembly of the battery pack assembly, and elastomeric protrusions provided on the surface of each holding frame and facing the opposing frame. In use, a conductor is positioned such that it lies between one or more elastomeric protrusions and one or more cell terminals such that urging the holding frames together using the fastening means causes the conductor to be urged into contact by the elastomeric protrusions with the one or more cell terminals. The invention described in this patent is effective for enabling rapid assembly and disassembly of the battery pack assembly for the recycling and reuse of cells within large format battery packs.

Other prior art in the field of large format battery pack assemblies has suggested the use of springs and/or other resilient means to urge a conductor into contact with the one or more cell terminals.

It would be advantageous to provide a battery pack assembly that is readily manufactured with fewer components for recycling and reuse.

It is therefore a first non-exclusive object of the invention to provide a large format battery pack assembly that is configured such that the components can be more readily manufactured and/or recycled.

Accordingly, a first aspect of the invention provides a battery pack assembly, the assembly comprising a first and second holding frame, a plurality of cells having terminals at each end thereof, fastening means for reversibly holding the first and second holding frames with respect to one another in a closed condition, an electrically conductive conductor plate for providing electrical contact to at least two of said plurality of cells, the conductor plate having respective protrusions for making contact with each of said at least two cells, the first holding frame bearing directly against said conductor plate to cause the protrusions of the conductor plate to make electrical contact with said at least two cells in said closed condition.

The conductor plate of the battery pack assembly of the present invention is provided with one or more protrusions, each protrusion configured to contact the one or more cell terminals. It has been surprisingly found that said fastening means or fastener are capable of generating sufficient compressive force to urge the protrusions of the conductive means into contact with the cell terminals for electrical connection. It has been further surprisingly found that quality electrical contacts are maintained even when the assembly undergoes vibration.

The realisation that a spring or an elastomeric protrusion, is not required to urge the conductive means into contact with the one or more cell terminals to maintain the electrical connection is surprising, especially in long term use and/or moving applications.

Advantageously, the battery pack assembly of the present invention comprises fewer components, which enables rapid assembly and disassembly, and ease of manufacture. Furthermore, the provision of elastomeric protrusions on one or more holding frames is avoided, which is advantageous from a manufacturing perspective.

In embodiments, the conductor plate may comprise one or more protrusions on a major surface, for example on a first major surface. In embodiments the conductor plate may comprise one or more rebates on a major surface, for example on a second major surface. In an embodiment the conductor plate may comprise a rebate on the second major surface that corresponds to the protrusion the first major surface of the conductor plate.

In embodiments, the one or more conductor plate(s) may be fabricated from a conductive plastics material or from one or more metal sheets. The one or more conductor plates may be fabricated from aluminium, e.g. aluminium sheet. The conductor plate, such as the metal sheet, e.g. aluminium sheet, may be between 0.1 to 1.0 mm in thickness, e.g. from any one of 0.1, 0.2, 0.3, 0.4, 0.5, 0.6, 0.7, 0.8, 0.9 mm to any one of 1.0, 0.9, 0.8, 0.7, 0.6, 0.5, 0.4, 0.3, or 0.2 mm in thickness. Preferably, the metal sheet, e.g. aluminium sheet, is between 0.6 to 1.0 mm in thickness, e.g. between 0.7 to 0.9 mm thick, or 0.8 mm thick. Conductor plates are typically rigid, meaning that they are self-supporting.

The protrusions may be fabricated, for example, by stamping a metal sheet, which forms the conductor plate. Advantageously, the protrusions aid electrical contact to be made between the conductor plate, e.g. one or more conductive plates, and the cell terminals. One or more (e.g. each) of the protrusions will extend from the first major surface of the conductor plate. The second major surface may have a corresponding depression. This is advantageously achieved by stamping from a thin conductive material, e.g. a metal sheet. In embodiments, the protrusions extend from 0.1 to 0.3 mm above the plane of the conductor plate, e.g. 0.1 to 0.2 mm or 0.2 to 0.3 mm.

Advantageously, the protrusions aid electrical contact to be made between the one or more conductor plates and the cell terminals. In a closed condition of the battery pack assembly, the protrusions of the conductor plate extend towards the cell terminals. The protrusions of the conductor plate are urged into contact with the cell terminals by tightening the fastening means, which provides effective electrical contact between the conductor and the cell terminals, when the battery pack assembly is in use. This prevents failure and/or disconnection of the cell terminals from the conductor.

The two or more holding frames may be fabricated from an electrically insulative material, for example, a polymer or plastic material. The two or more holding frames may be fabricated using any suitable method, e.g. injection moulding of a suitable material. Suitable materials for fabricating the holding frames include Nylon, PPE (polyphenylene ether), ABS (acrylonitrile butadiene styrene), PA (polyamide), PP (polypropylene), PS (polystyrene). Each holding frame may be any suitable thickness, e.g. above 1 mm thick, to withstand the compressive force applied by the fastening means or fastener.

In a preferred embodiment, the first and second holding frames are each fabricated from PP and the conductive plate is fabricated from aluminium sheet, which is stamped to form the protrusions, each of which extend by 0.1 to 0.3 mm from the plane of the conductor plate. It has been surprisingly found that a battery pack assembly according to the invention when assembled using fasteners tightened to a torque, of say between 0.5-10 Nm, preferably 0.5 to 5 Nm, e.g. 0.75 to 4 or 3 Nm, say 1 and 2 Nm, is able to maintain the contact between cells and conductor plates in the same manner as, for example, where a spring or an elastomeric protrusion is deployed. This is particularly surprising for static or non-static uses, where the assembly may undergo significant vibration.

The conductor plate preferably connects two or more cell terminals in parallel or series. Preferably, the arrangement of the conductor in each of the two holding frames is complementary, such that the conductors and cells together form a complete circuit when the plurality of cells are held within the two holding frames, electrically connecting all of the cells in the assembly in parallel and/or series. For example, the cells may be arranged with neighbouring cells alternatively positioned with the positive terminal upwards and the positive terminal downwards respectively, and the positive and negative terminals on each side being connected together, so that a complete circuit is formed.

The battery pack assembly may comprise more than one conductor plate. In embodiments, there may be provided two or more, e.g. three, four, five, or n conductor plates (where ‘n’ is a positive integer). For example, one or more conductor plate(s) may be associated with the first holding frame, and a second one or more conductor plate(s) associated with the second holding frame. The conductor plates may be any shape which would cover more than one cell terminal, such as a sheet, or rectangular, U-shaped, S-shaped, L-shaped, T-shaped, H-shaped, and so on.

The one or more conductor plates preferably connects two, three or more cell terminals in series. Preferably, the arrangement of the one or more conductor plates in each of the two holding frames is complementary, such that they form a complete circuit when the plurality of cells are held within the two holding frames, electrically connecting all of the cells in the assembly in series. For example, the cells may be arranged with neighbouring cells alternatively positioned with the positive terminal upwards and the positive terminal downwards respectively, and the positive and negative terminals on each side being connected together, so that a complete circuit is formed.

In embodiments, the conductor plate may comprise n protrusions for making contact with n cell terminals.

The one or more or each conductor plate, may further comprise an electrical terminus to connect the appropriate conductor or conductor, e.g. conductor plate, to external means, e.g. an external circuit, to use the electrical power.

The fastening means, in use, are configured to reversibly hold the first and second holding frames with respect to one another in a closed condition. The fastening means may be any suitable reversible fastening means known to the skilled person. For example, the fastening means may comprise or may consist of a plurality of fastening nuts and/or bolts. Each fastening nuts may each thread through a hole in each of the two holding frames and act to compress the assembly, encouraging contact between the cells and the conductor.

In embodiments, the battery pack assembly comprises of a plurality of cells positioned between two parallel holding frames, each cell being held longitudinally between the two holding frames by virtue of the fastening means being secured or ‘tightened’ to clamp the cells between the holding frames.

The cell assembly may be readily assembled and/or disassembled. Advantageously, in an assembled or closed configuration, the fastening means cause the protrusions of the conductor plate to be urged into contact with the two or more cell terminals. The fastening means or fastener causes terminals of the two cells to be urged against the conductor (and/or vice versa) and removal or loosening of the fastener or fastening means into an disassembled or open configuration enables the cells to be freed from the assembly. In a closed condition of the battery pack assembly, the protrusions of the conductor plate extend towards the cell terminals.

This allows for the complete disassembly of a large format battery pack assembly into its individual components. The ability to completely disassemble the assembly permits the module to be repaired via the replacement of individual cells or other components, allows individual components of the module to be reused for further applications at the end of the useful life of the complete assembly, and allows for improved recycling as each of the individual components of the module can be separated and sorted for recycling accordingly. Further, it also allows for upgrades or replacement of components as may be required over the service life of the assembly.

As well as assisting manufacturers to meet EU waste management legislation, the ability to reuse, repair and recycle individual components of battery modules would also save money and resources for the manufacturers. Individual or multiple cells may be replaced with ease, meaning the assemblies could be repeatedly rebuilt at end of life instead of being disposed. It also presents the opportunity for the reuse of cells from a module in other energy storage applications when they no longer perform in the original module application or when the module is no longer required.

One of the holding frames may be or may provide an access lid, which can be opened or removed to gain access to the cells.

The two or more holding frames may be shaped to accommodate cylindrical cells and/or cells of different shapes other than cylindrical ones, e.g. rectangular or other shapes.

The first and/or second holding frame may comprise one or more locating members. The one or more conductor plate(s) may comprise one or more cooperating members. The locating members and the cooperating members cooperating to ensure that the conductor plate(s) is/are appropriately located or locatable with respect to the holding frame. In an embodiment, the first and/or second holding frame may comprise, e.g. as a locating member, a formation and the conductor plate may comprise a corresponding portion. In an embodiment, the first and/or second holding frame comprises, e.g. as a locating member, one or more spigots and the conductor plate comprises one or more corresponding apertures. Advantageously, the first and/or second holding frames has plural locating members. The said plural locating members may cooperate to provide one or more cell locating structures. The cell locating structures provide regions of the first and/or second holding frame in which cells are located or locatable.

The one or more conductor plate(s) may comprise or consist of a sheet comprising apertures. Each aperture may correspond to a respective locating member, e.g. a respective formation.

In embodiments, the locating members may together define a plurality of whole or part generally cylindrical regions, each defined by a concave arcuate, e.g. side wall, section and at least one concave arcuate base protrusion wall section, wherein each generally cylindrical region may seat a cylindrical cell.

The one or more protrusions may be located between said conductor plate cooperating members. The conductor plate cooperating members may describe a conductor plate cooperating member array. The first and second (e.g. and n^{th}) contact may form a contact array. The contact array and the conductor cooperating member array may be displaced with respect to one another, such that a contact does not overlie a conductor cooperating member.

In embodiments, one or more, or each, holding frame may comprise a generally flat base and one or more side walls, e.g. upstanding side walls. In embodiments, one or more or each holding frame may comprise a side wall which upstands from the periphery of the base of the one or more, or each, holding frame. The side walls may be facing side walls. In embodiments, one or more or each holding frame may comprise an upstanding side wall which extends around the entire periphery of the base of the one or more, or each, holding frame. In alternative embodiments, the upstanding side wall may extend around a portion of the periphery of the base of the one or more, or each, holding frame. In an embodiment the side wall may be discontinuous. In embodiments in which the holding frame is to be used with cylindrical cells, at least one side wall, and preferably facing side walls, may further comprise a one or more concave arcuate sections complementary to the side wall of the cells to be inserted into the assembly.

In embodiments, one or more of the holding frames (e.g. each holding frame) may be configured or shaped to encase the ends of one or more cells, in use. For example, one or more (e.g. each) holding frame may encase a respective end of each cell, in use. In embodiments, one or more of the holding frames (for example, each holding frame) may encase one or more cell terminal(s), e.g. each cell terminal. In an embodiment one or more of the holding frames may comprise cooperating portions inboard of the periphery thereof. The cooperating portions may be shaped to cooperate with and/or correspond to the external periphery of at least a portion of one or more cells.

Advantageously, provision of an upstanding side wall and/or encasing one or more ends or terminals of the cells, in use, provides a more secure battery pack assembly with respect to the plurality of cells. This provides better contact between the conductor and the cell terminals, which is further enhanced by the resilient member, which is located between the conductor and one or more of the holding frames. This is particularly advantageous when no permanent fastening means (e.g. adhesive) are provided within the battery pack assembly, such that the assembly is rigid and stable in use, but may be readily disassembled into its component parts.

In alternative embodiments, each holding frame may comprise a base portion with no side walls. The holding frames may further comprise a plurality of protrusions extending perpendicularly from the base, for example to delimit or space the adjacent portions of the cells from one another. For example, the walls of the base protrusions may comprise a plurality of concave arcuate sections complementary to the facing portions of the cells to be inserted into the assembly.

In embodiments, each holding frame may define a plurality of whole or part generally cylindrical regions, each defined by a concave arcuate, e.g. side wall, section and at least one concave arcuate base protrusion wall section, wherein each generally cylindrical region may seat a cylindrical cell.

In embodiments, the battery pack assembly may comprise an n^{th} and/or an intermediate holding frame. In these embodiments, the battery pack assembly comprises a first plurality of cells located between the first outer holding frame and the n^{th} and/or intermediate holding frame, and a second plurality of cells located between the n^{th} and/or intermediate holding frame, and a second outer holding frame.

In embodiments, the holding frame (F)-cell (C)-holding frame (F) (i.e. FCF) architecture can be repeated plural times to form an FCFCF architecture, or FCFCF . . . CF architecture, that is, there may be more than two holding frames, e.g. a first outer holding frame and an intermediate holding frame between which a first plurality of cells is located, and a second outer holding frame, wherein a second plurality of cells is located between the second outer holding frame and the intermediate holding frame. In embodiments, there may be more than one intermediate holding frame, for example, two, three or more intermediate holding frames situated between the first and second outer holding frames, with a plurality of cells situated between each holding frame.

In such a case the ‘end’ frames, being those at the terminal edges of the battery pack, may have portions to receive the facing cell or cells whereas the ‘intermediate’ frames, being those between the end frames, may have a first side having portions to receive the facing cell or cells and a second side having portions to receive the facing cell or cells.

In embodiments, the battery pack assembly comprises one or more conduction breaking means or conduction breaker. A conduction breaking means or conduction breaker may be positioned between each cell terminal, and the conductor or conductor, which may be a conductor plate. Preferably, a conduction breaking means or conduction breaker is provided between every cell terminal and the associated conductor or conductor. The purpose of the one or more conduction breaking means of conduction breaker is to break the electrical circuit between a cell and the conductor or conductor, when said cell exceeds a prescribed electrical and/or thermal limit. Upon exceeding a prescribed electrical and/or thermal limit, the conduction breaking means of conduction breaker severs the connection of the failed cell, i.e. a cell that has exceeded a prescribed electrical and/or thermal limit, isolating said failed cell from the rest of the battery pack assembly.

The conduction breaking means or conduction breaker may comprise a first conductive portion for making contact with the cell terminal, a second conductive portion for making contact with the conductor or conductor, an insulating portion, and a conduction breaker portion. The conduction breaking means or conduction breaker may comprise a metallic alloy, or a multi-metallic element and may comprise a bimetal fuse. The conduction breaker portion may comprise a low melting material, for example, a metal such as silver, or silver-plated copper, tin, or zinc, or alloys of the same, which melts upon exceeding the electrical and/or thermal limit determined by the melting point of the material.

Advantageously, the contact between the conduction breaking means or conduction breaker with both the conductor one on major surface, and the cell terminal on the opposite major surface, is increased upon ‘tightening’ of the fastening means when the battery pack assembly is under compression. More advantageously, the one or more conduction breaking means or conduction breaker allow the battery pack assembly to continue to function upon failure of an individual cell, by isolating the one or more failed cells from the other functioning cells in the battery pack assembly.

In embodiments, the battery pack assembly comprises a monitoring means or monitor for monitoring the status of each cell. The monitoring means may comprise an integrated electrical circuit, which monitors the status of each cell by detecting the number of triggered conduction breaking means or conduction breakers resulting from failed cells, i.e. a cell that has exceeded a prescribed electrical and/or thermal limit, within the battery pack assembly. The monitoring means may comprise a method of determining the condition of the battery pack assembly. For example, the monitoring means may transmit data, which has been collected about the status of each cell within the assembly, to be fed through an algorithm to compare with the optimal function of the assembly, to determine the number of fully functioning cells and the number of failed cells. Advantageously, this provides information on the overall condition and remaining useful life of the battery pack assembly. More advantageously, this information may be used to inform the user of maintenance requirements, and of potential safety hazards from using an under-performing battery pack assembly.

The battery pack assembly may be any format including laminates, pouch, cylindrical, and/or prismatic.

The design of the assembly also allows for the integration of liquid cooling for high power applications.

In an embodiment the battery pack assembly has a mass of 12 kg or more and/or a power storage of 1 kWh or more. In an embodiment the battery pack assembly is a large format battery pack.

The battery pack assembly of the invention may be readily demountable and/or separable into its constituent parts, thereby allowing for the replacement or maintenance of one or more of the cells within the battery pack assembly.

A further aspect of the invention provides a method for assembling a battery pack assembly, the method comprising providing a first holding frame and a second holding frame for location of a plurality of cells therebetween, locating a first conductor plate between the first holding frame and the plurality of cells, the first conductor comprising at least one protrusion for making contact with a first cell terminal and a second protrusion for making contact with a second cell terminal, locating a second conductor plate between the second holding frame and the plurality of cells, and providing fastening means for reversibly holding the first and second holding frames with respect to one another in a closed condition and causing the first holding frame to bear directly against said first conductor plate to cause the protrusions of the conductor plate to make electrical contact with the cell terminals.

The method may further comprise providing a third holding frame and locating a second plurality of cells between the second holding frame and the third holding frame.

The method may further comprise locating a third conductor between the second holding frame and the second plurality of cells. The method may further comprise locating a fourth conductor between the second holding frame and the second plurality of cells.

The battery pack assembly of the invention may be used as a power source for consumer goods, vehicles, for example, electric vehicles or as a renewable energy store (for example when linked to a renewable energy source such as solar, wind or tide power generator).

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. For the avoidance of doubt, the terms “may”, “and/or”, “e.g.”, “for example” and any similar term as used herein should be interpreted as non-limiting such that any feature so-described need not be present. Indeed, any combination of optional features is expressly envisaged without departing from the scope of the invention, whether or not these are expressly claimed. The applicant reserves the right to change any originally filed claim or file any new claim accordingly, including the right to amend any originally filed claim to depend from and/or incorporate any feature of any other claim although not originally claimed in that manner.

Embodiments of the invention will now be described by way of example only with reference to the accompanying drawings in which:

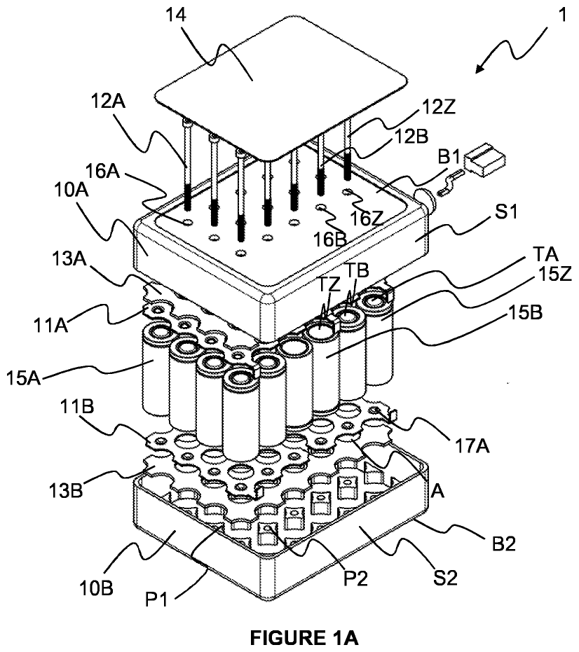

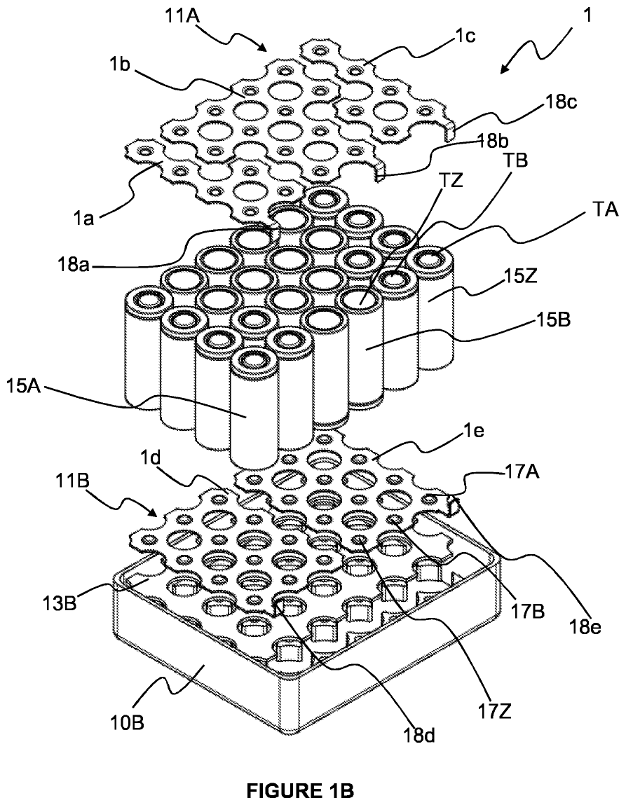

FIGS. 1A to 1B are exploded views of a battery pack assembly comprising a resilient means according to a comparative example;

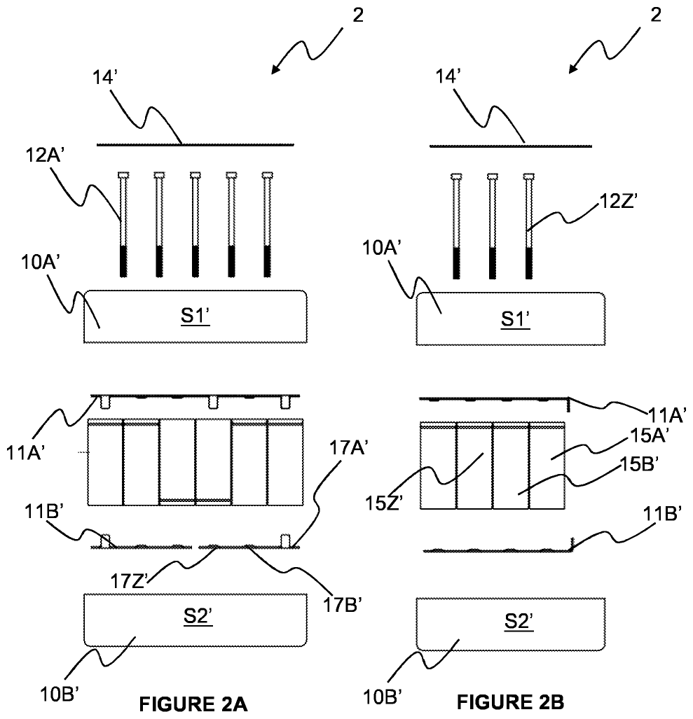

FIG. 2A to 2C are exploded views of a battery pack assembly according to the first embodiment of the invention;

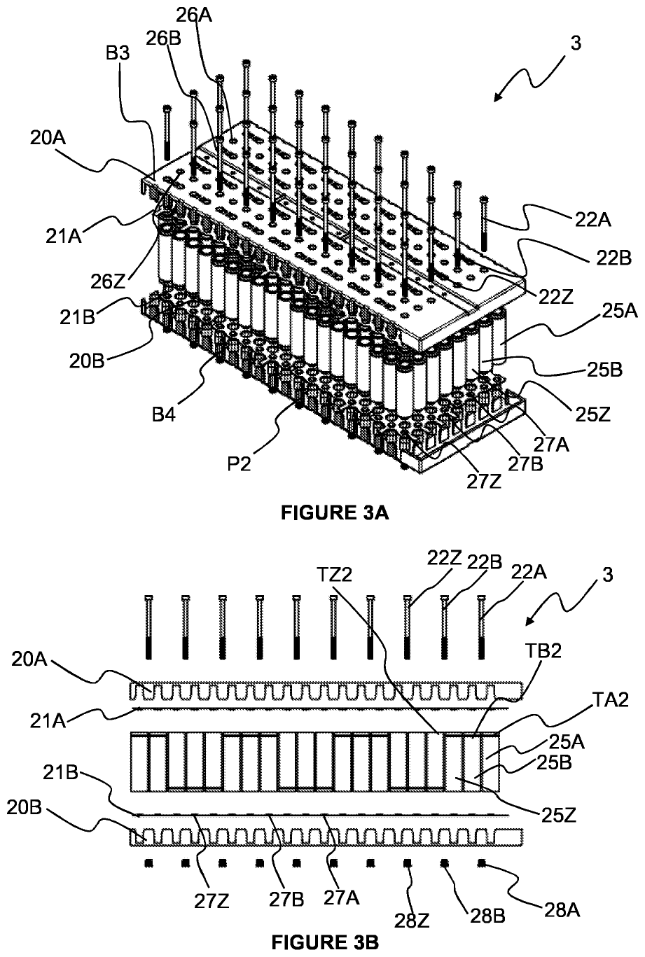

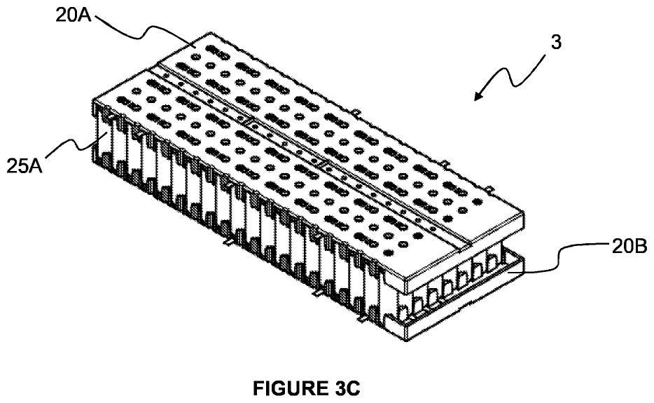

FIGS. 3A to 3B are exploded views of a battery pack assembly according to the second embodiment of the invention; and

FIG. 3C is the battery pack of FIGS. 3A and 3B in a closed condition.

Referring now to FIGS. 1A to 1B, there is shown a battery pack assembly 1 according to a comparative example. The battery pack assembly 1 is not an embodiment of the invention.

The battery pack assembly 1 comprises a first holding frame 10A, a second holding frame 10B, a first conductor 11A, a second conductor 11B, a plurality of fasteners 12A, 12B, . . . 12Z, a first resilient member 13A, and a second resilient member 13B and a plurality of cells 15A, 15B, . . . 15Z (a 6×4 array is shown in this assembly).

The first holding frame 10A comprises a lid 14. The second holding frame 10B may optionally also comprise a lid.

The battery pack assembly 1 is configured in use to hold a plurality of cells 15A, 15B, . . . 15Z between the first holding frame 10A and the second holding frame 10B. The battery pack assembly 1 is configured to hold twenty-four cells, e.g. lithium ion batteries. For convenience, only three cells are labelled in FIG. 1A. The plurality of cells 15A, 15B, . . . 15Z are cylindrical in shape although the battery pack assembly 1 may also be configured to hold cells of a different shape.

The first holding frame 10A and the second holding frame 10B are each generally rectangular, and each comprise a flat base B1, B2, and a peripheral side wall S1, S2 respectively. The side walls S1, S2 upstand from the periphery of the base B1, B2 of the first and second holding frame 10A, 10B respectively to form an enclosure that is open to receive the respective terminals of the plurality of cells 15A, 15B, . . . 15Z.

The plurality of cells 15A, 15B, . . . 15Z are held longitudinally between the first holding frame 10A and the second holding frame 10B when the battery pack assembly 1 is in an assembled configuration. Each base B1, B2 of the first and second holding frame 10A, 10B comprises a plurality of concave arcuate side wall sections, e.g. P1 and a plurality of base protrusions, e.g. P2, that provide cell locating structures between which portions of each cell 15A, 15B, . . . 15Z are received.

The first holding frame 10A further comprises slots 16A, 16B, . . . 16Z for receiving the fasteners 12A, 12B, . . . 12Z. The fasteners 12A, 12B, . . . 12Z are bolts, fifteen bolts being provided. Although the number is not critical, if the number of cells is C×R, the number of bolts is preferably (C-1)×(R-1). The slots 16A, 16B, . . . 16Z are configured to receive the fasteners 12A, 12B, . . . 12Z and as such there are fifteen slots provided.

The second holding frame 10B also comprises slots (not shown) for receiving the fasteners 12A, 12B, . . . 12Z such that each fastener, for example 12A, is inserted into the slot 16A of the first holding frame 10A and is received within a corresponding slot (not shown) in the second holding frame 10B. The fasteners 12A, 12B, . . . 12Z are secured in place, e.g. by nuts.

The first conductor 11A and the second conductor 11B are located in the battery pack assembly 1 to connect at least two of the plurality of cells 15A, 15B, . . . 15Z. The first conductor 11A is positioned between the first resilient member 13A and the terminals at the first end TA, TB, . . . TZ of each of the plurality of cells 15A, 15B, . . . 15Z. In a like manner, the second conductor 11B is positioned between the second resilient member 13B and the second terminals (not shown) of the plurality of cells 15A, 15B, . . . 15Z.

As best shown in FIG. 1B, the first conductor 11A comprises three individual conductive plates 1a, 1b, 1c, and the second conductor 11B comprises two individual conductive plates 1d, 1e. Each conductive plate 1a, 1b, 1c, 1d, 1e comprises a terminal 18a, 18b, 18c, 18d, 18e for connection to external means for use of the electrical power generated by the battery pack assembly.

The conductive plates 1a, 1b, 1c, 1d, 1e comprise plural protrusions, e.g. 17A, 17B, . . . 17Z shown for the conducive plate 1e. There is provided one protrusion per cell terminal such that the conductive plates 1a to 1e are in electrical contact with each cell terminal via a protrusion.

In an assembled configuration, the holding plate 10A is positioned adjacent the resilient member 13A, and the conductive plates 1a, 1b, 1c are positioned between the resilient member 13A and the first cell terminals TA, TB, . . . TZ at the first end of the battery pack assembly 1. The conductive plate 1a extends across six cell terminals of the cells 15A, the conductive plate 1b extends across a further twelve cell terminals of the cells 15B, the conductive plate 1c extends across a further six cell terminals of the cells 15Z.

Similarly, in an assembled configuration, the holding plate 10B is positioned adjacent the resilient member 13B, and the conductive plates 1d, 1e are positioned between the resilient member 13B and the second cell terminals (not shown) at the second end of the battery pack assembly 1. The conductive plate 1d extends across twelve cell terminals of each of the cells 15A and half of the cells 15B, and the conductive plate 1e extends across a further twelve cell terminals of the remaining half of cells 15B and each of the cells 15Z.

In this way, the twenty-four cells 15A, 15B, . . . 15Z are connected in series.

The first and second conductor 11A, 11B, and the first and second resilient members 13A, 13B each comprise apertures, e.g. A. The apertures, e.g. A are located in areas that are not in contact with the cell terminals, e.g. TA, TB, . . . TZ when the battery pack assembly 1 is assembled and correspond and cooperate with the cell locating structures.

In use, the fasteners 12A, 12B, . . . 12Z are received in the slots 16A, 16B, . . . 16Z, and are configured using compressive forces to reversibly hold the first holding frame 10A and the second holding frame 10B with respect to one another in a closed or assembled condition.

In the closed or assembled condition, the fasteners 12A, 12B, . . . 12Z cause terminals of the plurality of cells 15A, 15B, . . . 15Z to be urged against the first conductor 11A and the second conductor 11B.

The first resilient member 13A functions to urge the first conductor 11A into contact with the terminals TA, TB, . . . TZ at the first end of each of the plurality of cells 15A, 15B, . . . 15Z. In a like manner, the second resilient member 13B functions to urge the first conductor 11B into contact with the terminals at the second end (not shown) of each of the plurality of cells 15A, 15B, . . . 15Z.

The first resilient member 13A and the second resilient member 13B are fabricated as a unitary body from silicone rubber, which is particularly effective material for use in performing the aforementioned function by extending into depressions corresponding to each of the plural protrusions, e.g. 17A, 17B, . . . 17Z, provided on the first and second conductor 11A, 11B when a compressive force is applied to the battery pack assembly 1.

Advantageously, this provides additional safety performance without compromising the ease of assembly/disassembly of the battery pack assembly 1. Moreover, the unitary nature of both the first resilient member 13A and the second resilient member 13B enable ease of fabrication, removal and/or replacement for refurbishing or recycling the components of the battery pack assembly 1 when disassembled into its constituent parts.

The fasteners 12A, 12B, . . . 12Z are reversible, and as such, removal or loosening of the fasteners 12A, 12B, . . . 12Z enables the plurality of cells 15A, 15B, . . . 15Z to be freed from the battery pack assembly 1, when in an opened or disassembled condition.

Referring now to FIGS. 2A and 2B, there is shown exploded views of a battery pack assembly 2 according to the first embodiment of the invention.

The battery pack assembly 2 does not comprise a first or second resilient member 13A, 13B. Other than this difference, the battery pack assembly 2 comprises common features to those described for FIGS. 1A and 1B, and as such, these features are designated with a prime (′) and will not be described further.

It has been surprisingly found that the battery pack assembly 1 may be configured such that the first and second resilient members 13A, 13B are not required. Instead, the fastening means 12A, 12B, . . . 12Z may be tightened such that the protrusions, e.g. 17A, 17B . . . 17Z of the first and second conductor 11A, 11B are urged into contact with the respective cell terminal, e.g. TA, TB, . . . TZ, to provide a robust assembly without the need for the first and/or second resilient members 13A, 13B.

Referring now to FIGS. 3A and 3B, there is shown exploded views of a battery pack assembly 3 according to the second embodiment of the invention. Referring also to FIG. 3C, there is shown the battery pack 3 in a closed condition.

The features of the battery pack assembly 3 are similar and perform substantially the same functions as those shown for the battery pack assemblies 1 and 2 shown in FIGS. 1A and 2A. These features are prefixed with a ‘2’ rather than a ‘1’, e.g. 21 rather than 11. Only the differences will be described.

The battery pack assembly 3 comprises a first holding frame 20A, a second holding frame 20B, a first conductor 21A, a second conductor 21B, and a plurality of fasteners 22A, 22B, . . . 22Z.

In this embodiment, the first and second holding frames 20A, 20B do not have side walls. Instead, the first and second holding frames 20A, 20B each comprise a plurality of base protrusions, e.g. 2P only, each of which correspond to a cell terminal, e.g. TA. Additionally, there is no lid present in this embodiment.

There are further shown nuts 28A, 28B, . . . 28Z for securing to the fasteners 25A, 25B, . . . 25Z, which are bolts, to provide compressive forces to the battery pack assembly 3.

The first conductor 21A and the second conductor 21B each comprise protrusions, e.g. 27A, 27B, . . . 27Z. As with the battery pack assembly 2 shown in FIG. 2A, the fastening means 22A, 22B, . . . 22Z may be tightened such that the protrusions, e.g. 27A, 27B . . . 27Z of the first and second conductor 21A, 21B are urged into contact with the respective cell terminal, e.g. TA2, TB2, . . . TZ2, to provide a robust assembly without the need for the first and/or second resilient members 13A, 13B.

Advantageously, the battery pack assemblies 2 and 3 are absent the first and second resilient members 13A, 13B of FIGS. 1A and 1B. Therefore, the assemblies comprise fewer components, rapid assembly and disassembly is enabled, and it is easier to manufacture over those assemblies comprising a resilient means, e.g. that disclosed in our patent GB2545567.

In a preferred embodiment, the first and second holding frames are each fabricated from PP and the conductive plate is fabricated from aluminium sheet, which is stamped to form the protrusions, each of which extend by 0.1 to 0.3 mm from the plane of the conductor plate. It has been surprisingly found that a battery pack assembly according to the invention can generate sufficient torque, i.e. between 1 and 2 Nm, which is comparable to a battery pack assembly comprising, for example, a spring or an elastomeric protrusion.

It will be appreciated by those skilled in the art that several variations to the aforementioned embodiments are envisaged without departing from the scope of the invention. For example, instead of nuts and bolts (and threaded holes into which the bolts are located), other fastening means which can be tightened to clamp or urge the plates towards each other may be provided.

It will also be appreciated by those skilled in the art that any number of combinations of the aforementioned features and/or those shown in the appended drawings provide clear advantages over the prior art and are therefore within the scope of the invention described herein.

1. A battery pack assembly, the assembly comprising a first and second holding frame, a plurality of cells having terminals at each end thereof, one or more fasteners for reversibly holding the first and second holding frames with respect to one another in a closed condition, an electrically conductive conductor plate for providing electrical contact to at least two of said plurality of cells, the electrically conductive conductor plate having respective protrusions for making contact with each of said at least two cells, the first holding frame bearing directly against said electrically conductive conductor plate to cause the protrusions of the electrically conductive conductor plate to make electrical contact with said at least two cells in said closed condition.

2. An assembly according to claim 1, wherein the assembly comprises more than one electrically conductive conductor plate.

3. An assembly according to claim 1, wherein the electrically conductive conductor plate is fabricated from sheet metal.

4. An assembly according to claim 3, wherein the protrusions are provided as stamps in the sheet metal.

5. (canceled)

6. An assembly according to claim 1, wherein the first and second holding frames are parallel and each cell of the plurality of cells is held longitudinally between the two holding frames.

7. An assembly according to claim 1, wherein the first holding frame and second holding frame are fabricated from an insulative material.

8. An assembly according to claim 1, wherein at least one of the first holding frame or second holding frame comprises one or more locating members to provide one or more cell locating structures.

9. An assembly according to claim 8, wherein the one or more electrically conductive conductor plates comprises cooperating members for cooperation with the locating members of the first and/or second holding frames.

10. An assembly according to claim 1, wherein at least one of the first holding frame and the second holding frame comprises a base portion.

11. (canceled)

12. An assembly according to any preceding claim 1, wherein said at least one of the first holding frame and the second holding frame comprises base protrusions extending perpendicularly from the base portion.

13. An assembly according to claim 1, wherein one or more of the base protrusions comprise a plurality of concave arcuate sections, the radius of curvature being generally equal to the radius of one of the plurality of cells, so that a cell is at least partially received by the concave arcuate section.

14. An assembly according to any preceding claim 1, further comprising a third holding frame.

15. An assembly according to claim 1, wherein one of the first holding frame and the second holding frames is or provides an access lid, which is openable or removable to provide access to the cells.

16. An assembly according to claim 1, wherein at least one of the first holding frame and the second holding frame comprises one or more terminals for connection to an external electrical circuit.

17. An assembly according to claim 1, wherein the electrically conductive conductor plate comprises an electrical terminus for connecting the electrically conductive conductor plates to an external circuit.

18. An assembly according to claim 1, further comprising one or more frictionally retained conduction breakers.

19.-20. (canceled)

21. A method for assembling a battery pack assembly, the method comprising providing a first holding frame and a second holding frame for location of a plurality of cells therebetween, locating a first conductor plate between the first holding frame and the plurality of cells, the first conductor comprising at least one protrusion for making contact with a first cell terminal and a second protrusion for making contact with a second cell terminal, locating a second conductor plate between the second holding frame and the plurality of cells, and providing a fastener for reversibly holding the first and second holding frames with respect to one another in a closed condition and causing the first holding frame to bear directly against said first conductor plate to cause the protrusions of the conductor plate to make electrical contact with the cell terminals.

22. A method according to claim 21, further comprising providing a third holding frame and locating a second plurality of cells between the second holding frame and the third holding frame.

23. A method according to claim 22, further comprising locating a third conductor between the second holding frame and the second plurality of cells.

24. A method according to claim 23, further comprising locating a fourth conductor between the second holding frame and the second plurality of cells.
